(19) United States
(12) Patent Application Publication
(10) Pub. No.: US 2021/0240520 A1
(43) Pub. Date: Aug. 5, 2021

(54) METHOD AND SYSTEM FOR RESUMING INTERRUPTED DATABASE BACKUP OPERATIONS

(71) Applicant: EMC IP Holding Company LLC, Hopkinton, MA (US)

(72) Inventors: Navneet Upadhyay, Ghaziabad (IN); Shelesh Chopra, Bangalore (IN)

(21) Appl. No.: 16/782,101

(22) Filed: Feb. 5, 2020

(51) Int. Cl. G06F 9/48; G06F 11/14

(52) U.S. Cl. CPC G06F 9/485; G06F 2201/80; G06F 2209/486; G06F 11/1451

(57) ABSTRACT

In general, the invention relates to a method for performing backing operations. The method includes receiving a user instruction to perform a backup operation on a user asset on a client device, determining that a prior backup operation on the user asset was interrupted, in response to the determination, generating a data file difference subset using a control file and a recovery catalog, wherein the control file is associated with the user asset and the recovery catalog is associated with at least the prior backup operation, and initiating the backup operation using the data file difference subset.

### BACKGROUND

Database protection defines the process of protecting database data using a secondary storage. More specifically, protection of the database data often entails replicating database data, sending the replicated data to a secondary storage across a network, and storing the replicated data on the secondary storage.

### SUMMARY

In general, in one aspect, the invention relates to a method for performing backup operations. The method includes receiving a user instruction to perform a backup operation on a user asset on a client device, determining that a prior backup operation on the user asset was interrupted, in response to the determination, generating a data file difference subset using a control file and a recovery catalog, wherein the control file is associated with the user asset and the recovery catalog is associated with at least the prior backup operation, and initiating the backup operation using the data file difference subset.

In general, in one aspect, the invention relates to a system that includes a processor and a client protection agent, which when executed by the processor performs a method. The method includes receiving a user instruction to perform a backup operation on a user asset on a client device, determining that a prior backup operation on the user asset was interrupted, in response to the determination, generating a data file difference subset using a control file and a recovery catalog, wherein the control file is associated with the user asset and the recovery catalog is associated with at least the prior backup operation, and initiating the backup operation using the data file difference subset.

In general, in one aspect, the invention relates to a non-transitory computer readable medium which includes computer readable program code, which when executed by a computer processor enables the computer processor to perform a method. The method includes receiving a user instruction to perform a backup operation on a user asset on a client device, determining that a prior backup operation on the user asset was interrupted, in response to the determination, generating a data file difference subset using a control file and a recovery catalog, wherein the control file is associated with the user asset and the recovery catalog is associated with at least the prior backup operation, and initiating the backup operation using the data file difference subset.

### BRIEF DESCRIPTION OF DRAWINGS

FIG. 1A shows a system in accordance with one or more embodiments of the invention.

FIG. 1B shows a client device in accordance with one or more embodiments of the invention.

FIG. 1C shows a backup storage system in accordance with one or more embodiments of the invention.

FIGS. 2A-2C show flowcharts describing a method for resuming interrupted database backup operations in accordance with one or more embodiments of the invention.

FIGS. 3A and 3B show flowcharts describing a method for performing database backup operations in accordance with one or more embodiments of the invention.

FIG. 4 shows a flowchart of a method for manually interrupting database backup operations in accordance with one or more embodiments of the invention.

FIG. 5 shows an exemplary computing system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

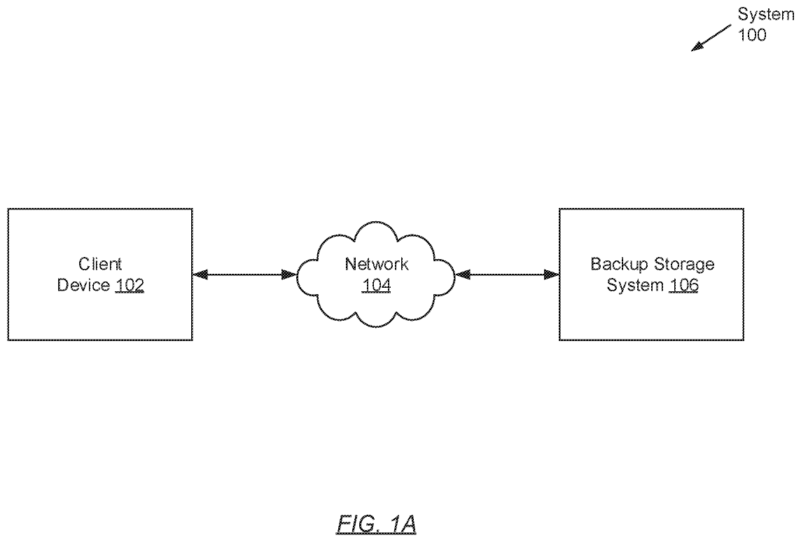

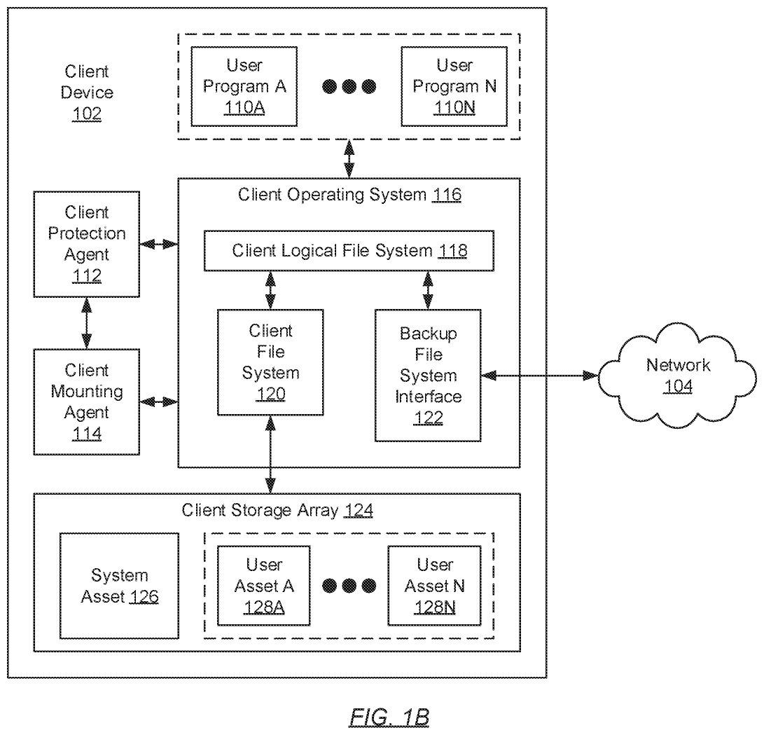

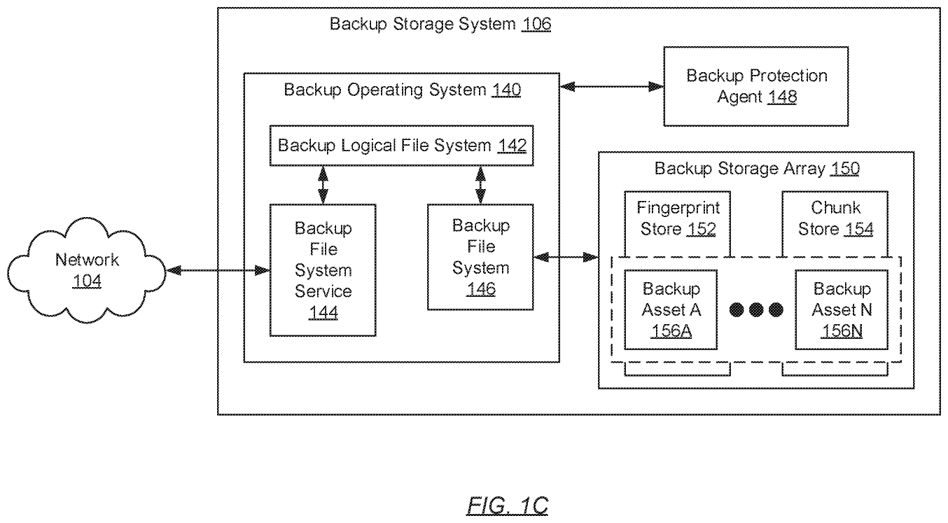

In the following description of FIGS. 1A-5, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and system for resuming interrupted database backup operations. Specifically, one or more embodiments of the invention enables the option to resume database backup operations that were interrupted without restarting the database operations from scratch. The resumed database backup operations, in contrast with restarting interrupted database backup operations from scratch, may provide mechanisms through which interrupted database backup operations may be resumed from the point of interruption and not require the duplication of previously completed portions of backup operations for a given database. Additionally, the database backup operations may be manually interrupted by a user of the system.

FIG. 1A shows a system in accordance with one or more embodiments of the invention. The system (100) may include a client device (102) operatively connected to a backup storage system (106). Each of these system (100) components is described below.

In one embodiment of the invention, the above-mentioned system (100) components may operatively connect to one another through a network (104) (e.g., a local area network (LAN), a wide area network (WAN) such as the Internet, a mobile network, etc.). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components. Moreover, the above-mentioned system (100) components may communicate with one another using any combination of wired and/or wireless communication protocols.

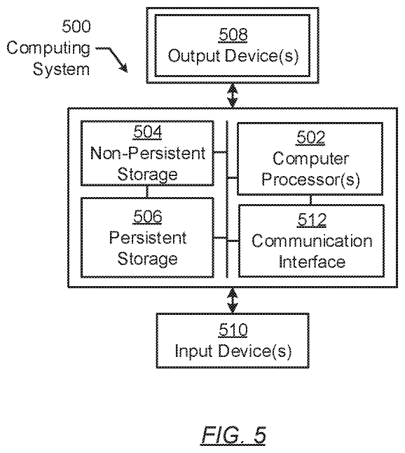

In one embodiment of the invention, a client device (102) may represent any physical appliance or computing system designed and configured to receive, generate, process, store, and/or transmit digital data, as well as to provide an environment in which one or more computer programs may execute thereon. The computer programs (not shown) may, for example, implement large-scale and complex data processing; or implement one or more services offered locally or over the network (104). Further, in providing an execution environment for any computer programs installed thereon, a client device (102) may include and allocate various resources (e.g., computer processors, memory, storage, virtualization, network bandwidth, etc.), as needed, to the computer programs and the tasks (or processes) instantiated thereby. One of ordinary skill will appreciate that a client device (102) may perform other functionalities without departing from the scope of the invention. Examples of a client device (102) may include, but are not limited to, a desktop computer, a laptop computer, a server, a mainframe, or any other computing system similar to the exemplary computing system shown in FIG. 5. Moreover, a client device (102) is described in further detail below with respect to FIG. 1B.

In one embodiment of the invention, a backup storage system (106) may represent a data backup, archiving, and/or disaster recovery storage system. The backup storage system (106) may be implemented using one or more servers (not shown). Each server may refer to a physical server, which may reside in a datacenter, or a virtual server, which may reside in a cloud computing environment. Additionally or alternatively, the backup storage system (106) may be implemented using one or more computing systems similar to the exemplary computing system shown in FIG. 5. Furthermore, the backup storage system (106) is described in further detail below with respect to FIG. 1C.

While FIG. 1A shows a configuration of components, other system (100) configurations may be used without departing from the scope of the invention.

FIG. 1B shows a client device in accordance with one or more embodiments of the invention. The client device (102) may include one or more user programs (110A-110N), a client protection agent (112), a client mounting agent (114), a client operating system (116), and a client storage array (124). Each of these client device (102) components is described below.

In one embodiment of the invention, a user program (110A-110N) may refer to a computer program that may execute on the underlying hardware of the client device (102). Specifically, a user program (110A-110N) may be designed and configured to perform one or more functions, tasks, and/or activities instantiated by a user of the client device (102). Accordingly, towards performing these operations, a user program (110A-110N) may include functionality to request and consume client device (102) resources (e.g., computer processors, memory, storage (124), virtualization, network bandwidth, etc.) by way of service calls to the client operating system (116). One of ordinary skill will appreciate that a user program (110A-110N) may perform other functionalities without departing from the scope of the invention. Examples of a user program (110A-110N) may include, but are not limited to, a word processor, an email client, a database client, a web browser, a media player, a file viewer, an image editor, a simulator, a computer game, or any other computer executable application.

In one embodiment of the invention, the client protection agent (112) may refer to a computer program that may execute on the underlying hardware of the client device (102). Specifically, the client protection agent (112) may be designed and configured to perform client-side database backup and recovery operations. To that extent, the client protection agent (112) may protect one or more databases (also referred herein as system assets (126) and/or user assets (128A-128N)) on the client device (102) against data loss (i.e., backup the database(s)); and reconstruct one or more databases on the client device (102) following such data loss (i.e., recover the database(s)). One of ordinary skill will appreciate that the client protection agent (112) may perform other functionalities without departing from the scope of the invention.

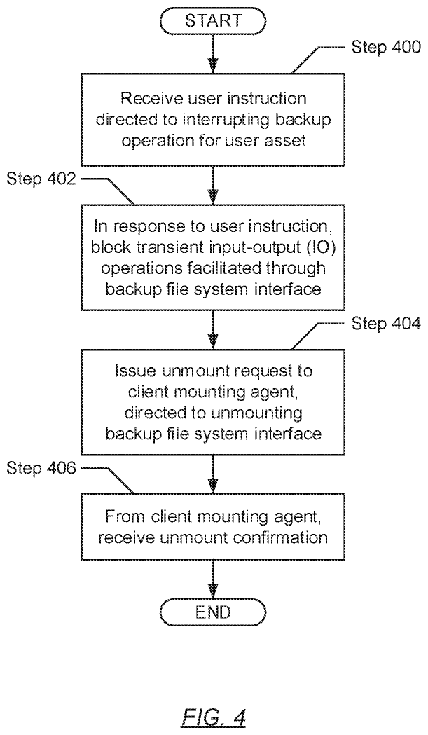

In one embodiment of the invention, the client mounting agent (114) may refer to a computer program that may execute on the underlying hardware of the client device (102). Specifically, the client mounting agent (114) may be designed and configured to perform client-side database mounting and unmounting operations. To that extent, the client mounting agent (114) may include functionality to perform one or more of the various steps outlined below with respect to FIG. 4, which may be directed to facilitating the removal of a backup storage file system from the client logical file system (118) and backup file system interface (122) (both described below) of the client device (102) in response to a user instruction directed to interrupting backup operation. One of ordinary skill will appreciate that the client mounting agent (114) may perform other functionalities without departing from the scope of the invention.

In one embodiment of the invention, the client operating system (116) may refer to a computer program that may execute on the underlying hardware of the client device (102). Specifically, the client operating system (116) may be designed and configured to oversee client device (102) operations. To that extent, the client operating system (116) may include functionality to, for example, support fundamental client device (102) functions; schedule tasks; mediate interactivity between logical (e.g., software) and physical (e.g., hardware) client device (102) components; allocate client device (102) resources; and execute or invoke other computer programs executing on the client device (102). One of ordinary skill will appreciate that the client operating system (116) may perform other functionalities without departing from the scope of the invention.

For example, the client operating system (116) may facilitate user program (110A-110N) interaction with user asset (128A-128N) data stored locally on the client device (102) or remotely over the network (104). In facilitating the aforementioned interaction, the client operating system (116) may implement a client logical file system (118). The client logical file system (118) may represent a collection of in-memory data structures maintained, by the client operating system (116), to manage the various accessible user asset (128A-128N) data stored locally on the client device (102) and/or remotely on the backup storage system (106). Further, the client logical file system (118) may expose an application programming interface (API) through which the user program(s) (110A-110N) may manipulate—i.e., via one or more file operations—any granularity of locally and/or remotely stored user asset (128A-128N) data. These file operations, requested by the user program(s) (110A-110N), may subsequently be delivered to the client file system (120) or backup file system interface (122) for processing.

In one embodiment of the invention, the client file system (120) may represent a physical file system (also referred to as a file system implementation). A physical file system may refer to a collection of subroutines concerned with the physical operation of one or more physical storage devices (described below). The client file system (120), in this respect, may be concerned with the physical operation of the client storage array (124). Accordingly, the client file system (120) may employ client storage array (124) device drivers (or firmware) (not shown) to process requested file operations from the user program(s) (110A-110N). Device drivers enable the client file system (120) to manipulate physical storage or disk blocks as appropriate.

In one embodiment of the invention, the backup file system interface (122) may represent a computer program that may execute on the underlying hardware of the client device (102). Specifically, the backup file system interface (122) may be designed and configured to facilitate the access and manipulation of remotely stored database data as if the aforementioned database data were stored locally on the client device (102). Accordingly, the backup file system interface (122) may, in part, implement a distributed file system (DFS), which may employ any known DFS protocol (e.g., the network file system (NFS) protocol). A DFS may refer to a mechanism through which files (e.g., database data) may be stored and accessed based on client-server architecture over a network (104). Particularly, in a DFS, one or more central appliances (e.g., the backup storage system (106)) store files that can be accessed, with proper authorization permissions, by any number of remote clients (e.g., the client device (102)) across the network (104). Furthermore, the backup file system interface (122) may include functionality to issue remote procedure calls (RPCs) directed to accessing and manipulating any granularity of database data remotely stored on the backup storage system (106). The invention is not limited to the aforementioned protocols.

In one embodiment of the invention, the client storage array (124) may refer to a collection of one or more physical storage devices (not shown) on which various forms of digital data—e.g., a system asset (126) and one or more user assets (128A-128N) (described below)—may be consolidated. Each physical storage device may encompass non-transitory computer readable storage media on which data may be stored in whole or in part, and temporarily or permanently. Further, each physical storage device may be designed and configured based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the client storage array (124) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or more embodiments of the invention, a system asset (126) may represent a database, or a logical container to and from which related digital data, or any granularity thereof, may be stored and retrieved, respectively. A system asset (126) may occupy a portion of a physical storage device or, alternatively, may span across multiple physical storage devices, of the client storage array (124). Furthermore, a system asset (126) may refer to a composite of various database objects including, but not limited to, one or more control files, and one or more recovery catalogs (discussed below, not shown).

In one embodiment of the invention, an user asset (128A-128N) may represent a database, or a logical container to and from which related digital data, or any granularity thereof, may be stored and retrieved, respectively. An user asset (128A-128N) may occupy a portion of a physical storage device or, alternatively, may span across multiple physical storage devices, of the client storage array (124). Furthermore, an user asset (128A-128N) may refer to a composite of various database objects including, but not limited to, one or more data files, and one or more control files (all not shown). Each of these user asset (128A-128N) subcomponents is described below.

In one embodiment of the invention, a data file may refer to a database object that stores database data. Database data may encompass computer readable content (e.g., images, text, video, audio, machine code, any other form of computer readable content, or a combination thereof), which may be generated, interpreted, and/or processed by any given user program (110A-110N). Further, a data file may store database data in (a) undeduplicated form or (b) deduplicated form. In brief, the latter form of database data may be produced through the application of data deduplication on the former form of the database data. That is, undeduplicated database data may entail computer readable content that may or may not include redundant information. In contrast, deduplicated database data may result from the elimination of any redundant information found throughout the undeduplicated computer readable content and, accordingly, may instead reflect a content recipe of the undeduplicated computer readable content. A content recipe may refer to a sequence of chunk identifiers (or pointers) associated with (or directed to) unique database data chunks consolidated in physical storage. Collectively, the sequence of chunk identifiers (or pointers)—representative of the deduplicated database data—may be used to reconstruct the corresponding undeduplicated database data. Moreover, a given chunk identifier for a given database data chunk may encompass a cryptographic fingerprint or hash of the given database data chunk.

In one embodiment of the invention, a recovery catalog may refer to a database object that stores backup operation metadata. The recovery catalog may include entries for one or more backup operations. The recovery catalog entries may include metadata that includes information regarding successfully backed-up data files for a backup operation. The metadata may include data file identifiers, user asset identifiers, data file storage locations, and/or other types of metadata without departing from the scope of the invention.

In one embodiment of the invention, a control file may refer to a database object that stores system asset (126) and/or user asset (128A-128N) metadata (also referred to as database metadata). Database metadata may encompass information descriptive of the database (or system asset (126) and/or user asset (128A-128N)) status and structure. By way of examples, database metadata may include, but are not limited to, a database name assigned to the system asset (126) and/or the user asset (128A-128N), the name(s) and storage location(s) of one or more data files and/or recovery catalogs associated with the system asset (126) and/or the user asset (128A-128N), a creation timestamp encoding the date and/or time marking the creation of the system asset (126) and/or the user asset (126A-126N), etc.

While FIG. 1B shows a configuration of components, other client device (102) configurations may be used without departing from the scope of the invention.

FIG. 1C shows a backup storage system (106) in accordance with one or more embodiments of the invention. The backup storage system (106) may include a backup operating system (140), a backup protection agent (148), and a backup storage array (150). Each of these backup storage system (106) components is described below.

In one embodiment of the invention, the backup operating system (140) may refer to a computer program that may execute on the underlying hardware of the backup storage system (106). Specifically, the backup operating system (140) may be designed and configured to oversee backup storage system (106) operations. To that extent, the backup operating system (140) may include functionality to, for example, support fundamental backup storage system (106) functions; schedule tasks; mediate interactivity between logical (e.g., software) and physical (e.g., hardware) backup storage system (106) components; allocate backup storage system (106) resources; and execute or invoke other computer programs executing on the backup storage system (106). One of ordinary skill will appreciate that the backup operating system (140) may perform other functionalities without departing from the scope of the invention.

For example, the backup operating system (140) may facilitate backup asset (156A-156N) access and manipulation by one or more computer programs (e.g., backup protection agent (148)) executing locally on the backup storage system (106) or, alternatively, by one or more remote computing systems (e.g., client device (102)) over the network (104). In facilitating the aforementioned interaction, the backup operating system (140) may implement a backup logical file system (142). The backup logical file system (142) may represent a collection of in-memory data structures maintained, by the backup operating system (140), to manage the various accessible backup asset (156A-156N) data stored locally on the backup storage system (106). Further, the backup logical file system (142) may expose an application programming interface (API) through which the local computer programs and/or remote computing systems may manipulate—i.e., via one or more file operations—any granularity of locally stored backup asset (156A-156N) data. File operations, requested by the local computer programs, may be delivered to the backup file system (146) for processing, whereas file operations, requested by the remote computing systems, may be received and processed by the backup file system service (144).

In one embodiment of the invention, the backup file system service (144) may represent a computer program that may execute on the underlying hardware of the backup storage system (106). Specifically, the backup file system service (144) may be designed and configured to facilitate the authorized, remote access and manipulation of locally stored backup database data. Accordingly, the backup file system service (144) may, in part, implement a DFS (DFS), which may employ any known DFS protocol (e.g., the network file system (NFS) protocol). A DFS may refer to a mechanism through which files (e.g., database data) may be stored and accessed based on client-server architecture over a network (104). Particularly, in a DFS, one or more central appliances (e.g., the backup storage system (106)) store files that can be accessed, with proper authorization permissions, by any number of remote clients (e.g., the client device (102)) across the network (104). Furthermore, the backup file system service (144) may include functionality to service remote procedure calls (RPCs) directed to accessing and manipulating any granularity of backup database data locally stored on the backup storage system (106). The invention is not limited to the aforementioned protocols.

In one embodiment of the invention, the backup file system (146) may represent a physical file system (also referred to as a file system implementation). A physical file system may refer to a collection of subroutines concerned with the physical operation of one or more physical storage devices (described below). The backup file system (146), in this respect, may be concerned with the physical operation of the backup storage array (150). Accordingly, the backup file system (146) may employ backup storage array (150) device drivers (or firmware) (not shown) to process requested file operations from the local computer programs or the remote computing systems (via the backup file system service (144)). Device drivers enable the backup file system (146) to manipulate physical storage or disk blocks as appropriate.

In one embodiment of the invention, the backup protection agent (148) may refer to a computer program that may execute on the underlying hardware of the backup storage system (106). Specifically, the backup protection agent (148) may be designed and configured to perform server-side database backup and recovery operations. To that extent, the backup protection agent (148) may receive database data, submitted by the client device (102), to store as backup assets (156A-156N) on the backup storage array (150) during database backup operations; and, conversely, may retrieve backup database data from the backup storage array (150) during database recovery operations. One of ordinary skill will appreciate that the backup protection agent (148) may perform other functionalities without departing from the scope of the invention.

In one embodiment of the invention, the backup storage array (150) may refer to a collection of one or more physical storage devices (not shown) on which various forms of digital data—e.g., one or more backup assets (156A-156N) (described below)—may be consolidated. Each physical storage device may encompass non-transitory computer readable storage media on which data may be stored in whole or in part, and temporarily or permanently. Further, each physical storage device may be designed and configured based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the backup storage array (150) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, the backup storage array (150) may include a fingerprint store (152) and a chunk store (154), which may collectively include deduplicated database data. Deduplicated database data may result from the elimination of any redundant information found throughout the database data in undeduplicated form. Accordingly, instead of reflecting the binary composition of the undeduplicated database data in its entirety, deduplicated database data may alternatively reflect reduced information in the form of a content recipe of the representative, undeduplicated computer readable content. The aforementioned content recipe may refer to a sequence of chunk identifiers (or pointers) associated with (or directed to) unique database data chunks identified throughout the undeduplicated database data. Any unique database data chunks, along with their respective chunk identifiers (i.e., cryptographic fingerprints or hashes), may be indexed in appropriate physical storages—e.g., the chunk store (154) and the fingerprint store (152), respectively.

In one embodiment of the invention, the fingerprint store (152) may represent a repository for maintaining chunk identifiers. Each chunk identifier may be indexed by way of a fingerprint store (152) entry (not shown), which may store a mapping relating the chunk identifier to a storage identifier. A chunk identifier (also referred to as a fingerprint or hash) may represent a digital signature that uniquely identifies an associated database data chunk. Further, a chunk identifier may be produced by submitting the associated database data chunk through a hash function, which may employ any existing cryptographic mapping algorithm. As such, a chunk identifier may be outputted by the hash function given the associated database data chunk as input. Meanwhile, a storage identifier may represent a character or bit string that uniquely identifies a storage location in the backup storage array (150). By way of an example, a storage identifier may encompass a tuple reflecting (a) a storage device identifier uniquely assigned to a given physical storage device (not shown) of the backup storage array (150); and (b) a binary address assigned to a starting byte (or storage block) in the given physical storage device at which the database data chunk may be physically stored.

On the other hand, in one embodiment of the invention, the chunk store (154) may represent a repository for maintaining unique database data chunks. Each unique database data chunk may be indexed by way of a chunk store (154) entry (not shown), which may store a mapping relating a storage identifier (described above) to the unique database data chunk. A database data chunk may refer to a fragment or a partition of deduplicated database data. More specifically, a database data chunk may capture a unique byte pattern that may occur or recur throughout the undeduplicated database data.

In one embodiment of the invention, a backup asset (156A-156N) may refer to a deduplicated backup copy of a given user asset (128A-128N) (see e.g., FIG. 1B). For example, a backup asset (156A-156N) may represent a database, or a logical container to and from which related digital data, or any granularity thereof, may be stored and retrieved, respectively. A backup asset (156A-156N) may occupy a portion of a physical storage device or, alternatively, may span across multiple physical storage devices, of the backup storage array (150). Furthermore, a backup asset (156A-156N) may include a combination of various database objects including, but not limited to, one or more data files, one or more control files (described above), and one or more tag files (described below).

In one embodiment of the invention, a tag file may refer to a database object for storing parameters regarding backup operations. The tag file may include an “InProgress” parameter. The “InProgress” parameter may indicate whether a given the backup operation was completed successfully or was interrupted while in progress. The tag file may include other parameters and/or other information regarding various backup operations without departing from the scope of the invention.

While FIG. 1C shows a configuration of components, other backup storage system (106) configurations may be used without departing from the scope of the invention.

FIGS. 2A-2C show flowcharts describing a method for resuming interrupted database backup operations in accordance with one or more embodiments of the invention. The various steps outlined below may be performed by the client protection agent (see e.g., FIG. 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 2A, in Step 200, a user instruction directed to performing backup operation for a user asset on a client device is received. In one embodiment of the invention, the user instruction may specify the user asset of user assets on the client device for which the backup operation is to be performed. The user instruction may include other information without departing from the scope of the invention.

In Step 202, through a backup file system interface, the last-created data file directory (residing on a backup storage system) associated with the user asset is accessed. In one embodiment of the invention, the backup file system interface may allow the client protection agent on the client device to access and manipulate directories and/or directory contents on the backup storage system. The data file directory may include an identifier and/or other parameters that specify the time the last-created data file directory was created and/or modified and for which user asset is associated with the data file directory. The client may use the above and/or other information to identify and access the last-created data file directory without departing from the invention.

In Step 204, the last-created data file directory is searched to identify a tag file. In one embodiment of the invention, the client protection agent may utilize the backup file system interface to search the accessed last-created data file directory and identify the tag file. The tag file may have an identifier to differentiate it from the other data files stored in the data file directory. The tag file may include information regarding the backup operation associated with the data file directory. The tag file may include other information without departing from the scope of the invention.

In Step 206, the tag file is examined to retrieve an “InProgress” parameter value. In one embodiment of the invention, the “InProgress” parameter may be enabled or disabled. The “InProgress” parameter may indicate whether the last backup operation associated with the user asset was completed successfully or interrupted before successful completion. If the “InProgress” parameter is enabled, the previous backup operation associated with the user asset may have been interrupted before successful completion. If the “InProgress” parameter is disabled, the previous backup operation associated with the user may have been successfully completed.

In Step 208, a determination is made as to whether the “InProgress” parameter is enabled. Accordingly, in one embodiment of the invention, if it is determined that the “InProgress” parameter is enabled, then the previous backup of the user asset was interrupted and method proceeds to Step 212. On the other hand, if it is alternatively determined that the “InProgress” parameter is not enabled (i.e., disabled), the previous backup of the user asset was completed successfully, then the method proceeds to Step 210.

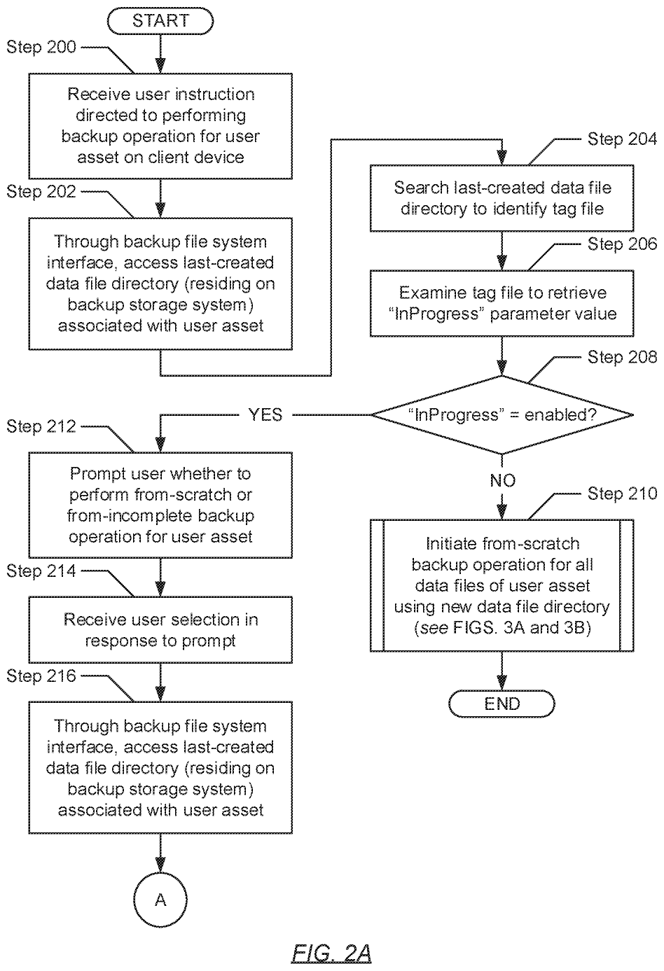

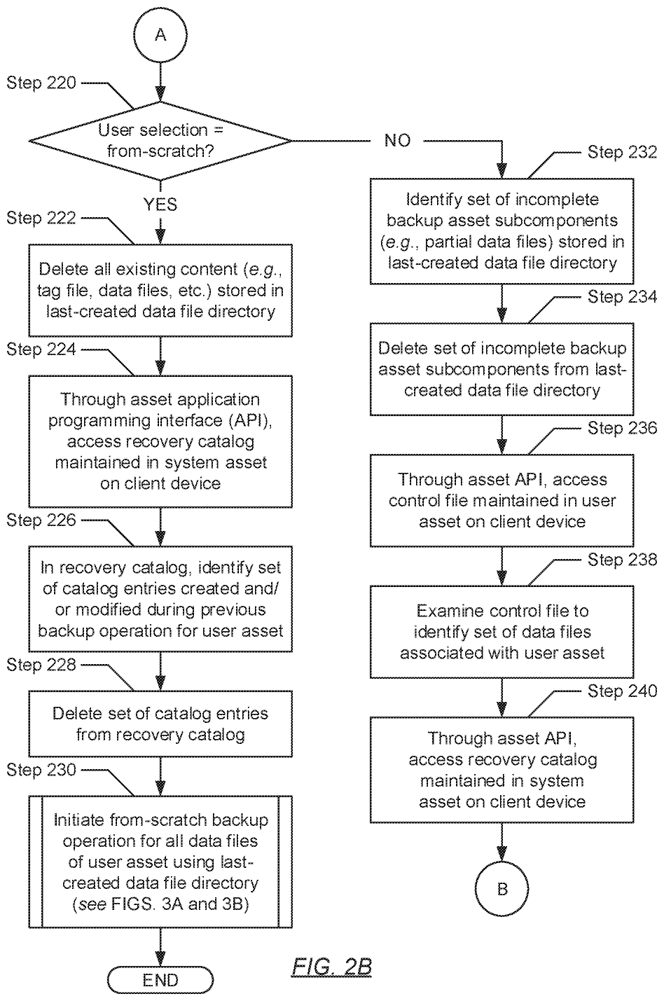

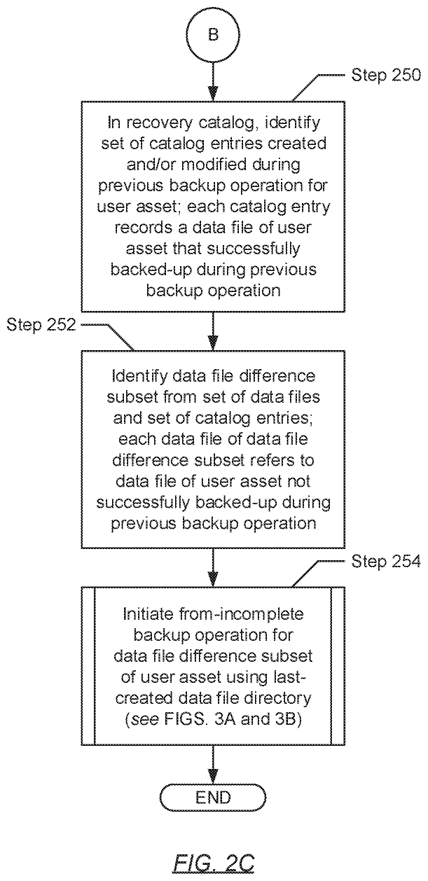

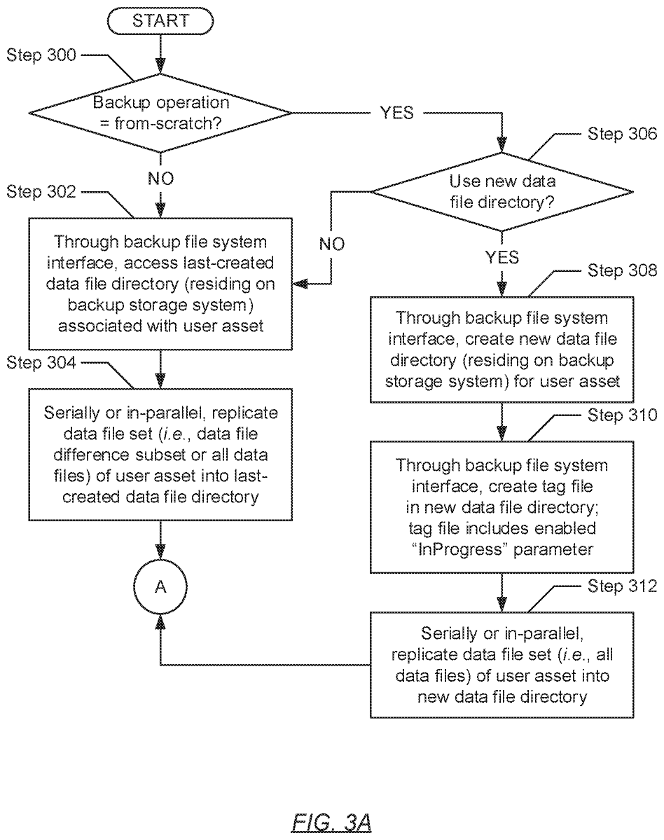

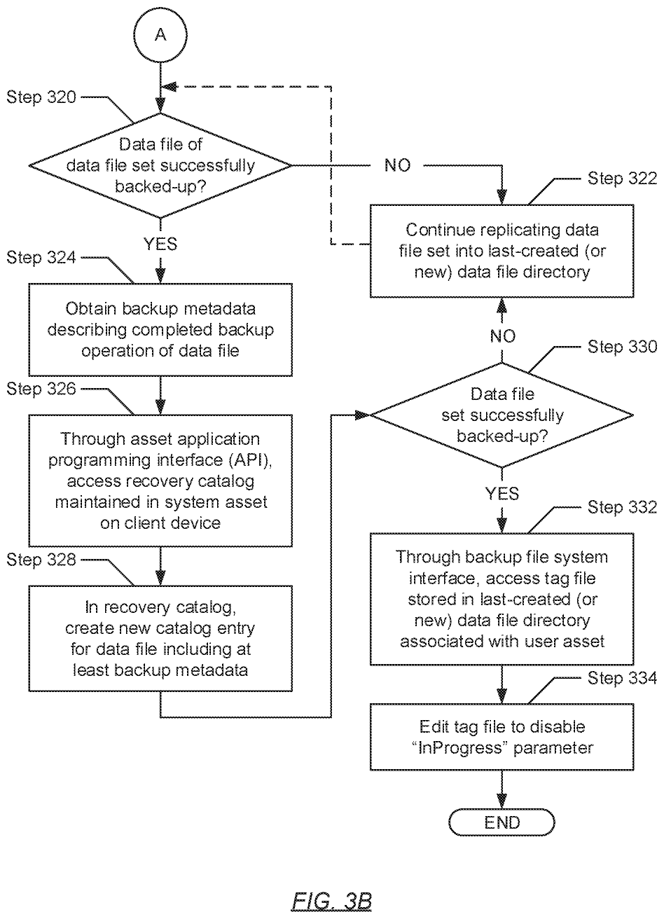

In Step 210, a from-scratch backup operation for all data files of the user asset using a new data file directory is initiated. Based on the determination above, the previous backup operation associated with the user asset stored in the last-created data file directory may have been completed successfully. Therefore, there may be no need to resume an interrupted backup operation. In response to the determination, a from scratch-backup operation may be initiated using a new data file directory. A from-scratch backup operation backs up all the data files of a user asset. A new data file directory may be used to create an image-based backup of the user asset at a later point in time compared to the previously created image-based backup stored in the last-created data file directory without overwriting and/or corrupting the previous image-based backup of the user asset in the last-created data file directory. For additional information regarding a from-scratch backup, see FIGS. 3A and 3B.

The method may end following Step 210.

Continuing with the discussion of FIG. 2A, in Step 212, a user is prompted to select whether to perform a from-scratch or from-incomplete backup operation for the user asset. Based on the determination above, the previous backup operation associated with the user asset may have been interrupted prior to successful completion. In response to this determination, the client protection agent may prompt a user of the system to select between performing a from-scratch backup or a from-incomplete backup. The from-scratch backup may restart the previous interrupted backup operation and back up all the data files associated with a user asset as discussed above. A from incomplete backup may back up only the unsuccessfully backed-up data files from the last backup operation of the user asset.

In Step 214, the user selection in response to the prompt is received. In one embodiment of the invention, the user selection may indicate whether a from-scratch backup operation or a from-incomplete backup operation is to be performed. The user selection may include a parameter that when enabled, indicates that a from-scratch backup operation was selected by the user to be performed, and when disabled, indicates that a from-incomplete backup operation was selected by the user to be performed. The user selection may include other information without departing from the invention.

In Step 216, through the backup file system interface, the last-created data file directory (residing on the backup storage system) associated with the user asset is accessed. As discussed above, the backup file system interface may allow the client protection agent on the client device to access and manipulate directories and/or directory contents on the backup storage system. The data file directory may include an identifier and/or other parameters that specify the time the last-created data file directory was created and/or modified and for which user asset is associated with the data file directory. The client may use the above and/or other information to identify and access the last-created data file directory without departing from the invention. The process then proceeds to FIG. 2B.

Turning to FIG. 2B, in Step 220, a determination is made as to whether the user selection is to perform a from-scratch backup operation. Accordingly, in one embodiment of the invention, if it is determined that the user selection is to perform a from-scratch backup operation, then the process proceeds to Step 222. On the other hand, if it is alternatively determined that the user selection is not to perform a from-scratch backup operation and, therefore, a from-incomplete backup operation is to be performed, then the process alternatively proceeds to Step 232.

In Step 222, all existing content (e.g., tag file, data files, etc.) stored in the last-created data file directory is deleted. Based on the above determination, the user selection may indicate a from-scratch backup operation is to be performed. In response to the determination, the client protection agent may delete all existing content stored in the last-created data file directory using the backup file system interface. The content stored on the last-created data file directory may include a tag file, data files, and/or other types of files without departing from the invention. In one embodiment of the invention, deleting existing content stored in the last-created data file directory may mitigate data corruption and/or data loss from overwriting existing content on the last-created data file directory.

In Step 224, through an asset application programming interface (API), a recovery catalog maintained in a system asset on the client device is accessed. In one embodiment of the invention, the asset API may be used by the client protection agent to access and/or manipulate any granularity of locally stored system asset data as discussed above. In one embodiment of the invention, the recovery catalog may include sets of entries for a user asset. The entries may include metadata of successfully backed-up data files for backup operations associated with a user asset. The metadata may include data file identifiers, a user asset identifier, timestamps and/or other types of metadata without departing from the invention.

In Step 226, in the recovery catalog, a set of recovery catalog entries created and/or modified during the previous backup operation for the user asset is identified. As discussed above, the recovery catalog may include entries that include metadata regarding successfully completed backups of data files. This may include entries of the successfully backed-up data files created during the last backup operation, which was interrupted. Based on the user selection, a from-scratch backup may be performed. In one embodiment of the invention the client protection agent may, through the asset API, identify a set of entries associated with the previous interrupted backup operation of the user asset. The entries may have user asset identifiers, timestamps, and/or other identifiers that allow the client protection agent to identify the set of entries associated with the previous backup operation for the user asset.

In Step 228, the set of recovery catalog entries is deleted from the recovery catalog. In one embodiment of the invention, the deletion of entries in the recovery catalog associated with the previous interrupted backup operation may mitigate data corruption and/or data loss due to overwriting present entries and/or duplicating entries.

In Step 230, a from-scratch backup operation for all data files of the user asset using the last-created data file directory is initiated. In one embodiment of the invention, a from-scratch backup operation may back up all the data files of a user asset into the last-created data file directory. The from-scratch backup operation may act as a complete replacement of the interrupted backup operation. For additional information regarding a from-scratch backup, see FIGS. 3A and 3B.

The method may end following Step 230.

Continuing with the discussion of FIG. 2B, in Step 232, a set of incomplete backup asset subcomponents (e.g., partial data files) stored in last-created data file directory is identified. In one embodiment of the invention, an interrupted backup operation may include incomplete backup asset subcomponents. The subcomponents may include incomplete or partial data files that were interrupted while being replicated into the last-created data file directory before successful completion of the backup operation. For additional details on replication, see FIGS. 3A and 3B. The subcomponents may also include identifiers, flags, and/or parameters that the client protection agent may use to identify them as incomplete backup asset subcomponents. The incomplete backup asset subcomponents may include other information and may be identified via other methods without departing from the invention.

In Step 234, the set of incomplete backup asset subcomponents from the last-created data file directory is deleted. In one embodiment of the invention, the deletion of incomplete backup asset subcomponents associated with the previous interrupted backup operation in the last-created data file directory may mitigate data corruption and/or data loss due to overwriting present incomplete backup asset subcomponents and/or duplicating incomplete backup asset subcomponents during the subsequent from-incomplete backup operation.

In Step 236, through an asset API, a control file maintained in the user asset on the client device is accessed. In one embodiment of the invention, a control file maintained in the user asset on the client may include metadata regarding the user asset and the data stored within. As discussed above, the control file may include name(s) and storage location(s) of one or more data files associated with the user asset. The control file may include other information without departing from the invention. As discussed above, the asset API may allow the client protection agent to access and manipulate files stored on the user asset.

In Step 238, the control file is examined to identify a set of data files associated with the user asset. In one embodiment of the invention, client protection agent, using the asset API, may examine the control file to identify a set of data files associated with the user asset. The examination may result in the identification of a set of data files associated with the user asset.

In Step 240, through an asset API, the recovery catalog maintained in the system asset on the client device is accessed. In one embodiment of the invention, the asset API may be used by the client protection agent to access and/or manipulate any granularity of locally stored system asset data as discussed above. In one embodiment of the invention, the recovery catalog may include sets of entries for a user asset. The entries may include metadata of successfully backed-up data files for backup operations associated with a user asset. The metadata may include data file identifiers, a user asset identifier, timestamps and/or other types of metadata without departing from the invention. The process then proceeds to FIG. 2C.

Turning to FIG. 2C, in Step 250, in the recovery catalog, a set of catalog entries created and/or modified during the previous backup operation for the user asset is identified. In one embodiment of the invention, each catalog entry may record a data file of the user asset that was successively backed-up during the previous backup operation. As discussed above, the recovery catalog entries may include identifiers and/or other information which may allow the client protection agent to identify the entries as entries created and/or modified during the previous backup operation.

In Step 252, a data file difference subset is identified. In one embodiment of the invention, each data file of the data file difference subset may refer to a data file of the user asset not successfully backed-up during the previous user asset backup operation. The data file difference subset may be identified by comparing the set of all data files associated with the user asset identified from the control file and the set of entries including the successfully backed-up data files of the previous backup operation from the recovery catalog. The difference between the data file set specified in the control file and the set of entries from the recovery catalog may result in the data file difference subset. The data file difference subset may include all the data files that were not successfully backed-up in the previous backup operation, which must be included in the subsequent from-incomplete backup operation.

In Step 254, a from-incomplete backup operation for the data file difference subset of the user asset using the last-created data file directory is initiated. In one embodiment of the invention, a from-incomplete backup operation may back-up the data files difference subset (i.e., only the data files of the user asset which were not successfully backed-up in the previous backup operation). The from-incomplete backup operation may be performed using the last data file directory to complete the image-based backup that experienced interruption. For additional information regarding a from-incomplete backup operation, see FIGS. 3A and 3B.

The method may end following Step 254.

FIGS. 3A and 3B show flowcharts describing a method for performing database backup operations in accordance with one or more embodiments of the invention. The various steps outlined below may be performed by the client protection agent (see e.g., FIG. 1B) of the client device. Further, while the various steps in the flowcharts are presented and described sequentially, one of ordinary skill will appreciate that some or all steps may be executed in different orders, may be combined or omitted, and some or all steps may be executed in parallel.

Turning to FIG. 3A, in Step 300, a determination is made as to whether the backup operation is a from-scratch backup operation. Accordingly, in one embodiment of the invention, if it is determined that the backup operation is a from-scratch backup operation, then the process proceeds to Step 302. On the other hand, if it is alternatively determined that the backup operation is not a from-scratch backup operation and is, therefore, a resumption of an interrupted backup operation (i.e., a from-incomplete backup operation), then the process proceeds to Step 306.

In Step 302, the last-created data file directory (residing on the backup storage system) associated with the user asset is accessed through the backup file system interface.

In Step 304, the data file set (i.e., data file difference subset or all data files) of the user asset is replicated into the last-created data file directory serially or in-parallel. In one embodiment of the invention, replication may refer to the copying of the data file set on the user asset into the last-created data file directory. The replication may be performed serially or in-parallel. Serial replication may refer to the replication of one data file at a time. For example, during serial replication, the first data file in the data file set may be replicated into the last-created data file directory, then the second data file may be replicated once the first data file replication is complete, and so on until all the data files in the data file set have been successfully replicated in the last-created data file directory. In-parallel replication may refer to the replication of all data files in the data file set into the last-created data file directory at the same time. The data file set may be replicated into the last-created data file directory via other and/or additional methods without departing from the invention.

In Step 306, a determination is made as to whether a new data file directory is to be used in the backup operation. Accordingly, in one embodiment of the invention, if it is determined that a new data file directory is to be used in the backup operation, then the process proceeds to Step 308. On the other hand, if it is determined that a new data file directory is not to be used and, therefore, the last-created data file directory associated with the user asset is to be used, then the process alternatively proceeds to Step 302.

In Step 308, a new data file directory (residing on the backup storage system) for the user asset is created through the backup file system interface. In one embodiment of the invention, the new data file directory may be used to store data files of the subsequent backup operation. The new data file directory may be created to store a new image-based backup without overwriting and/or corrupting previous image-based backups stored in previously created data file directories. The new data file directory may include other and/or addition files without departing from the invention.

In Step 310, a tag file is created in the new data file directory through the backup file system interface. In one embodiment of the invention, the tag file may include an enabled “InProgress” parameter. In one embodiment of the invention, the tag file may be used by the client protection agent to determine whether backup operations were successfully completed or interrupted. The “InProgress” parameter may include a binary value (i.e., enabled or disabled) that when enabled, may indicate that the backup operation associated with the tag file that includes the “InProgress” parameter is in progress (i.e., the backup operation may have been interrupted) as discussed above.

In Step 312, the data file set (i.e., all the data files) of the user asset is replicated into the new data file directory serially or in-parallel. In one embodiment of the invention, replication may refer to the copying of the data file set on the user asset into the new data file directory as discussed above. The replication may be performed serially or in-parallel. Serial replication may refer to the replication of one data file at a time into the new data file directory until all of the data files in the data file set have been replicated into the new data file directory. In-parallel replication may refer to the replication of all data files in the data file set into the new data file directory at the same time. The data file set may be replicated into the new data file directory via other and/or additional methods without departing from the invention. The process then proceeds to FIG. 3B.

Turning to FIG. 3B, in Step 320, a determination is made as to whether a data file of the data file set is successfully backed-up. Accordingly, in one embodiment of the invention, if it is determined that the data file of the data file set is successfully backed-up, then the process proceeds to Step 324. On the other hand, if it is determined that the data file of the data file set is not successfully backed-up, then the process proceeds to Step 322.

In Step 322, the replication of the data file set into the last-created (or new) data file directory is continued. In one embodiment of the invention, the backing-up of a data file set may not be an instantaneous operation. The method of performing database backup operations may wait until the current data file set is successfully backed-up before proceeding to the next step. In one embodiment of the invention there may be a flag in the data file directory in which the current data file set is being backed-up that indicates whether the data file set replication is in progress. The client protection agent may access and examine this flag to determine whether to wait while replication of a data file set continues or advance to the next step in the method.

In Step 324, backup metadata describing the completed backup operation of the data file is obtained. In one embodiment of the invention, the client protection agent may use the backup file system interface to obtain backup metadata of the successfully backed-up data file. The backup metadata may refer to data describing the successfully backed-up data file. As discussed above, the metadata may include a data file identifier, a user asset identifier, timestamps and/or other types of metadata without departing from the invention.

In Step 326, a recovery catalog maintained in the system asset on the client device is accessed through an asset API. In one embodiment of the invention, the asset API may be used by the client protection agent to access and/or manipulate any granularity of locally stored system asset data as discussed above.

In Step 328, a new catalog entry for the successfully backed-up data file including at least backup metadata is created in the recovery catalog. In one embodiment of the invention, the client protection agent, using the asset API, may create a new recovery catalog entry that includes the metadata obtained in Step 324.

In Step 330, a determination is made as to whether the data file set is successfully backed-up. Accordingly, in one embodiment of the invention, if it is determined that the data file set is successfully backed-up, then the process proceeds to Step 332. On the other hand, in another embodiment of the invention, if it is alternatively determined that the data file set is not successfully backed-up, then the process proceeds to Step 322.

In Step 332, the tag file stored in the last-created (or new) data file directory associated with the user asset is accessed through the backup file system interface. In one embodiment of the invention, the client protection agent may utilize the backup file system interface to access and search the data file directory and identify the tag file. As discussed above, the tag file may have an identifier to differentiate it from the other data files stored in the data file directory. The tag file may include information regarding the backup operation associated with the data file directory.

In Step 334, the tag file is edited to disable the “InProgress” parameter. In one embodiment of the invention, the client protection agent, through the backup file system interface, may disable the “InProgress” parameter. Disabling the “InProgress” parameter of the tag file may indicate that the backup operation is successfully completed.

The method may end following Step 334.

FIG. 4 shows a flowchart describing a method for manually interrupting database backup operations in accordance with one or more embodiments of the invention. The various steps outlined below may be performed by the client protection agent (see e.g., FIG. 1B). Further, while the various steps in the flowcharts are presented and described sequentially, one of ordinary skill will appreciate that some or all steps may be executed in different orders, may be combined or omitted, and some or all steps may be executed in parallel.

Turning to FIG. 4, in Step 400, a user instruction directed to interrupting backup operation for a user asset is received. In one embodiment of the invention, the user instruction may be directed to interrupting a backup operation which is currently in progress. The user instruction may include the particular backup operation to interrupt, the user asset associated with the backup operation, and/or any other information regarding the targeted backup operation without departing from the invention.

In Step 402, in response to the user instruction, the transient input-output (IO) operations facilitated through the backup file system interface are blocked. In one embodiment of the invention, the input-output (IO) operations may include reading and/or writing of data to and from the backup storage system. The input-output (IO) operations may include other operations without departing from the invention. A transient input-output operation may refer to an input-output operation that is in progress. For example, a transient write operation may include an operation that is in the process of writing data from the client device to the backup storage system through the backup file system interface. The blocking of the transient input-output (IO) operations may result in an interrupted user asset backup operation. In one embodiment of the invention, an “InProgress” parameter associated with the user asset backup operation may be updated in tag file in response to the interruption of the backup operation on the user asset.

In Step 404, an unmount request directed to unmounting the backup file system interface is issued to the client mounting agent. As discussed above, the client mounting agent oversees all mounting operations on the client device. In one embodiment of the invention, unmounting the backup file system interface disables future input-output operations and may render the backup storage system inaccessible to the client protection agent on the client device.

In Step 406, unmount confirmation from the client mounting agent is received. In one embodiment of the invention, the client mounting agent may unmount the backup file system interface in response to the unmount request sent by the client protection agent. After unmounting the backup file system interface, the client mounting agent may send confirmation of the unmounting of the backup file system interface to the client protection agent. The unmount confirmation may notify the client protection agent that the backup file system interface was successfully unmounted.

The method may end following Step 406.

FIG. 5 shows an exemplary computing system in accordance with one or more embodiments of the invention. The computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a central processing unit (CPU) and/or a graphics processing unit (GPU). The computing system (500) may also include one or more input devices (510), such as a touchscreen, keyboard, mouse, microphone, touchpad, electronic pen, or any other type of input device. Further, the communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

In one embodiment of the invention, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for performing backup operations:
receiving a user instruction to perform a backup operation on a user asset on a client device;
determining that a prior backup operation on the user asset was interrupted;
in response to the determination, generating a data file difference subset using a control file and a recovery catalog, wherein the control file is associated with the user asset and the recovery catalog is associated with at least the prior backup operation; and
initiating the backup operation using the data file difference subset.

2. The method of claim 1, wherein the control file specifies a plurality of data files in the user asset to be backup during the backup operation.

3. The method of claim 2, wherein the recovery catalog specifies a second plurality of data files each of which were backed-up during the prior backup operation, wherein the second plurality of data files is a subset of the plurality of data files.

4. The method of claim 1, wherein determining that the prior backup operation on the user asset was interrupted comprises:
identifying a tag file associated with the user asset; and
determining that a parameter in the tag file specifies that the prior backup operation was in-progress.

5. The method of claim 4, further comprising:
after the backup operation has been performed:
updating a second parameter in a second tag file to specifies that the backup operation was successful,
wherein performing the backup operation comprises deleting the tag file.

6. The method of claim 1, further comprising:
making a second determination that a request to perform a from-incomplete backup been received,
wherein the data file difference subset is generated in response the determination and the second determination.

7. The method of claim 1, further comprising:
prior to initiating the backup operation, initiating deletion of incomplete backup asset subcomponents in a last-created data file directory on a backup storage system, wherein copies of data files specified in the data file difference subset are stored in the last-created data file directory during the backup operation.

8. A system, comprising:
a processor;
a client protection agent, which when executed by the processor performs a method, the method comprising:
receiving a user instruction to perform a backup operation on a user asset on a client device;
determining that a prior backup operation on the user asset was interrupted;
in response to the determination, generating a data file difference subset using a control file and a recovery catalog, wherein the control file is associated with the user asset and the recovery catalog is associated with at least the prior backup operation; and
initiating the backup operation using the data file difference subset.

9. The system of claim 8, wherein the control file specifies a plurality of data files in the user asset to be backup during the backup operation.

10. The system of claim 9, wherein the recovery catalog specifies a second plurality of data files each of which were backed-up during the prior backup operation, wherein the second plurality of data files is a subset of the plurality of data files.

11. The system of claim 8, wherein determining that the prior backup operation on the user asset was interrupted comprises:
identifying a tag file associated with the user asset; and
determining that a parameter in the tag file specifies that the prior backup operation was in-progress.

12. The system of claim 11, wherein determining that the prior backup operation on the user asset was interrupted further comprises:
after the backup operation has been performed:
updating a second parameter in a second tag file to specifies that the backup operation was successful,
wherein performing the backup operation comprises deleting the tag file.

13. The system of claim 8, wherein the method further comprises:
making a second determination that a request to perform a from-incomplete backup been received,
wherein the data file difference subset is generated in response the determination and the second determination.

14. The system of claim 8, wherein the method further comprises:
prior to initiating the backup operation, initiating deletion of incomplete backup asset subcomponents in a last-created data file directory on a backup storage system, wherein copies of data files specified in the data file difference subset are stored in the last-created data file directory during the backup operation.

15. A non-transitory computer readable medium comprising computer readable program code, which when executed by a computer processor enables the computer processor to perform a method, the method comprising:
receiving a user instruction to perform a backup operation on a user asset on a client device;
determining that a prior backup operation on the user asset was interrupted;
in response to the determination, generating a data file difference subset using a control file and a recovery catalog, wherein the control file is associated with the user asset and the recovery catalog is associated with at least the prior backup operation; and
initiating the backup operation using the data file difference subset.

16. The non-transitory computer readable medium of claim 15, wherein the control file specifies a plurality of data files in the user asset to be backup during the backup operation.

17. The non-transitory computer readable medium of claim 16, wherein the recovery catalog specifies a second plurality of data files each of which were backed-up during the prior backup operation, wherein the second plurality of data files is a subset of the plurality of data files.

18. The non-transitory computer readable medium of claim 15, wherein determining that the prior backup operation on the user asset was interrupted comprises:
identifying a tag file associated with the user asset; and
determining that a parameter in the tag file specifies that the prior backup operation was in-progress.

19. The non-transitory computer readable medium of claim 18, wherein determining that the prior backup operation on the user asset was interrupted further comprises:
after the backup operation has been performed:
updating a second parameter in a second tag file to specifies that the backup operation was successful,
wherein performing the backup operation comprises deleting the tag file.

20. The non-transitory computer readable medium of claim 15, wherein the method further comprises:
making a second determination that a request to perform a from-incomplete backup been received,
wherein the data file difference subset is generated in response the determination and the second determination.
